(19) United States
(12) Patent Application Publication
(10) Pub. No.: US 2015/0278482 A1
(43) Pub. Date: Oct. 1, 2015

(54) SYSTEMS AND METHODS FOR SECURE LIFE CYCLE TRACKING AND MANAGEMENT OF HEALTHCARE RELATED INFORMATION

(71) Applicant: McKesson Financial Holdings, Hamilton (BM)

(72) Inventor: Ugo Mattera, Cumming, GA (US)

(73) Assignee: McKesson Financial Holdings, Hamilton (BM)

(21) Appl. No.: 14/227,768

(22) Filed: Mar. 27, 2014

(51) Int. Cl. G06F 19/00; G06F 17/30

(52) U.S. Cl. CPC G06F 19/3487; G06F 19/322; G06F 17/30117

(57) ABSTRACT

Certain embodiments herein relate to, among other things, secure life cycle tracking and management of information, such as healthcare related information or other sensitive information. An electronic file that includes such information may be tracked from the time it is received until the time it is deleted, in certain embodiments herein. The tracking may include storing identifications of users who accessed the file, locations at which the file was replicated or copied, a time at which the file was accessed, etc. By storing such information, users of healthcare related information may be notified or reminded about the status of the healthcare related information so that they may manage the information effectively. For example, the information may be deleted according to a deletion policy when it is no longer needed.

### TECHNICAL FIELD

Embodiments herein relate generally to healthcare related information, and more particularly, to systems and methods for tracking and management of healthcare related information.

### BACKGROUND

Patient healthcare information and other sensitive information may be shared between various healthcare provider entities, such as insurance providers and healthcare service providers. Healthcare professionals or employees of such entities may access the healthcare information to perform various services. In so doing, the employees may replicate healthcare information in various directories or file systems, where it may remain well beyond its intended purpose and without association to an owner or user of the information. Put another way, healthcare related information may not be tracked to the file level such that details associated with the file (e.g., a text file), such as identifications of users who accessed the file, locations at which the file was replicated throughout its use, or other information that may facilitate tracking of such files, are known to users or owners of the healthcare related information in the file. Such unintended circumstances may threaten the security and integrity of sensitive information, and may ultimately lead to security breaches and mishandling of sensitive healthcare records.

### BRIEF DESCRIPTION OF THE FIGURES

The detailed description of example embodiments is set forth below with reference to the accompanying figures. In the figures, the left-most digit(s) of a reference number identifies the figure in which the reference number first appears. The use of the same reference numbers in different figures indicates similar, but not necessarily the same or identical items.

FIG. 1 illustrates a schematic diagram of an example environment for securing healthcare related information, according to an example embodiment of the disclosure.

FIG. 2 illustrates a block diagram of an example computing system for implementing secure life cycle tracking and management of healthcare related information, according to an example embodiment of the disclosure.

FIG. 3 illustrates an example data flow diagram for exchanging information to facilitate secure life cycle tracking and management of healthcare related information, according to an example embodiment of the disclosure.

FIG. 4 is a flow diagram of an example process for implementing secure life cycle tracking and management of healthcare related information, according to an example embodiment of the disclosure.

FIG. 5 is a flow diagram of an example process for removing healthcare related information according to one or more policies, according to one example embodiment of the disclosure.

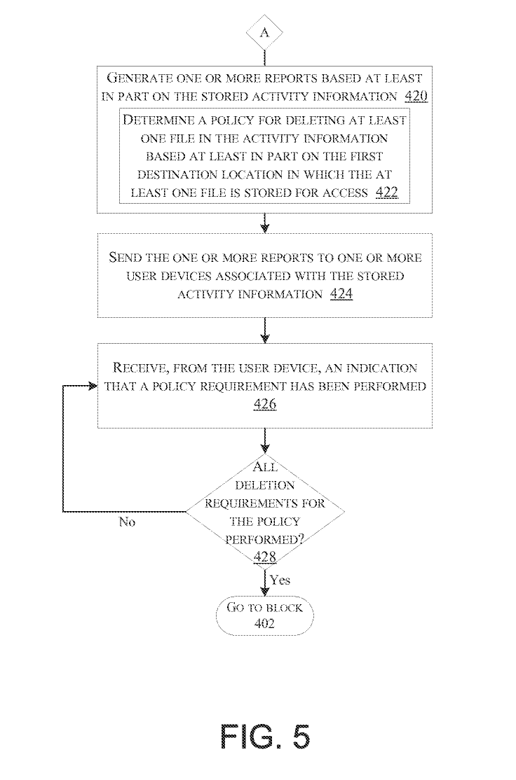

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art.

### DETAILED DESCRIPTION OF EXAMPLE EMBODIMENTS

Certain embodiments discussed herein relate to, among other things, secure life cycle tracking and management of information, such as healthcare related information or other sensitive information. An electronic file that includes such information may be tracked from the time it is received until the time it is deleted, in certain example embodiments herein. The tracking may include storing identifications of users who accessed the file, locations at which the file was replicated or copied, a time at which the file was accessed, etc. By storing such information, users of healthcare related information may be notified or reminded about the status of the healthcare related information so that they may manage the information effectively. For example, the information may be deleted according to a deletion policy when the healthcare related information is no longer needed. More detailed descriptions and examples of such processes are described below.

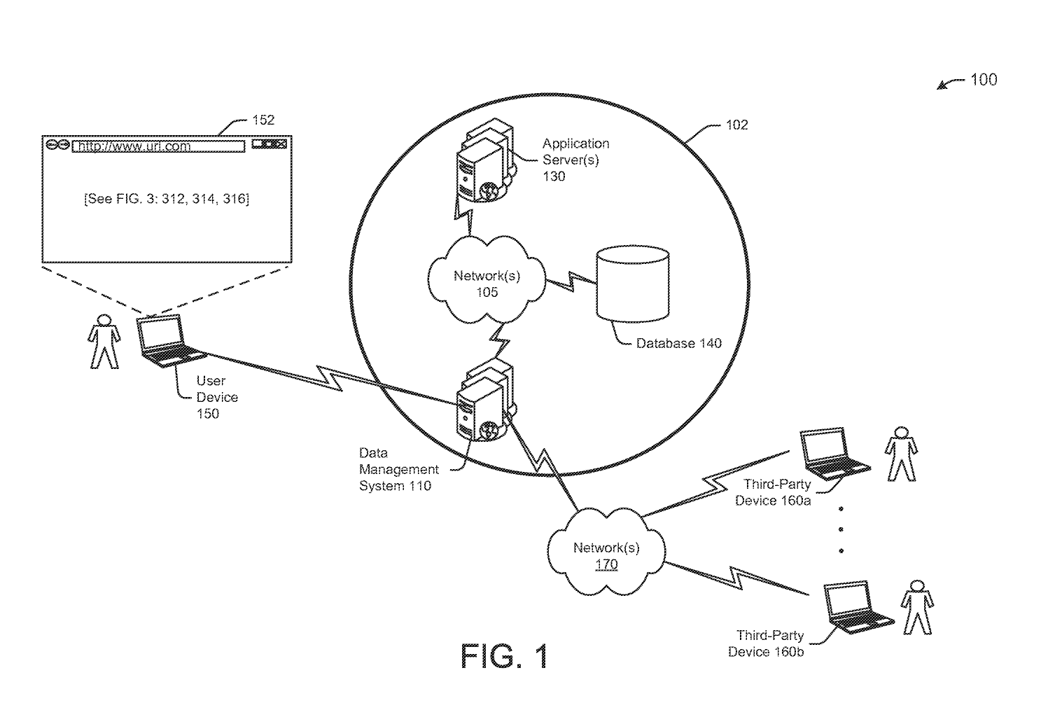

FIG. 1 depicts a schematic diagram of an example environment for securing healthcare related information, according to one example embodiment of the disclosure. One or more security techniques may be implemented in certain embodiments herein. A first technique may include securing access to the computing devices within the illustrated region 102 via a firewall or other security mechanisms that include various hardware, such as routers, other networking devices (not shown), etc., that may be used to restrict access to the devices within the illustrated region 102, as well as to implement hardware and/or software encryption, among other techniques, to secure information sent to and from the devices within the region 102. In this way, the data management system 110, the one or more application servers 130, and the one or more databases 140 may securely communicate healthcare related information with each other over the network 105 without unauthorized access from external devices.

Examples of such external devices may include, but are not limited to, one or more user devices 150 associated with a user or owner of the healthcare related information, and the third-party devices 160a-b associated with health plan administrators, adjudicators of healthcare claims, insurance companies, drug manufacturers, disease management entities, pharmacy point of service devices, labs, other healthcare provider systems (e.g., physician's practice management system, hospital or clinic computer systems (such as clinical, practice management, scheduling and/or e-prescribing systems), government and/or non-government entities providing clinical, financial, or administrative services, other providers of healthcare services for a patient, etc.), or other third-party entities. Certain example embodiments may not include such a technique for securing healthcare related information and may instead rely only on the following technique.

Certain example embodiments herein relate to securing healthcare related information by tracking the use of healthcare related information. Such tracking may include prompting a user of the user device 150 for information associated with the healthcare related information (referred to generally herein as activity information). For example, when a user requests to check out a file that includes healthcare related information, the user may be prompted to provide a destination location, such as a database or file system directory, to which the file may be stored. In this way, the user may indicate a destination location for a file irrespective of where the file may be actually copied by an operating system command or other application, in certain embodiments herein. An identification of the user who requested to check out the file, an identification of the file, an identification of the destination location, etc., may be captured and stored such that each time a file is accessed or checked out, the whereabouts of the file and the user who accessed the file, among other information, may be known. In this way, along with other techniques described below, systems and methods herein may track access to healthcare related information.

As used herein, access to a file that includes healthcare related information may include viewing the file, checking out the file, editing or modifying the file, adding the file, deleting the file, etc. In one example embodiment, the application server 130 may be used to facilitate at least a portion of such access. For example, the application server 130 may analyze the healthcare related information and provide the results of such analysis to the user device 150, where it may be viewed by a user.

In certain example embodiments herein, a file that includes healthcare related information may be deleted when the life cycle of the file has ended. The deletion may be performed in accordance with one or more policies. Certain example embodiments herein may also relate to generating one or more reports associated with the processes described herein. For example, a report may be generated and sent as a reminder or notification to users who accessed or checked out a file containing healthcare related information but have not checked that file back in to the system. Examples of the above descriptions will be provided in greater detail below.

In certain example embodiments herein, the data management system 110 illustrated in FIG. 1 may implement or facilitate the processes described herein. According to one example, the data management system 110 may receive healthcare related information over the network 170 from various computing devices, such as the third-party devices 160a-b. The data management system 110 may also store the received healthcare related information, for example, in the database 140 or another data storage device, in association with a third-party entity from which the healthcare related information was received, in one example embodiment.

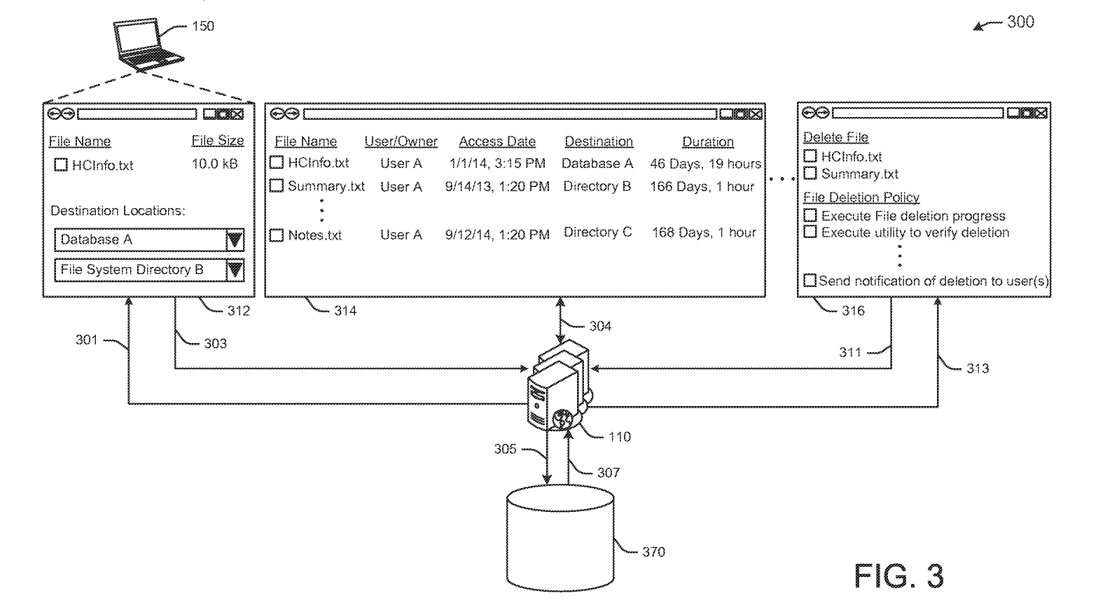

The data management system 110 may receive requests for the stored healthcare related information from the user device 150. Access to the healthcare related information may be granted only after successful authentication of a user who requested the access, in some embodiments. Upon successful authentication, the user may access or view only files for third-party entities to which the user has authorized access. In one aspect of the embodiment, the user may access or view files for only one third-party entity at a time to which the user has access. In this way, a user may not mix or integrate information across third-party entities. Example information displayed at the user device 150 via a webpage 152, or other information resource, to facilitate the processes described herein are described in greater detail in the illustrations 312, 314, and 316 of FIG. 3, as indicated in FIG. 1.

The data management system 110 may track access to files associated with the healthcare related information at least in part by requesting certain information from a user who desires to access the files, as described above. The data management system 110 may generate one or more reports based on such information received from the user, and may verify that the user deleted the files, for example, from the database 140 or other storage, according to a particular policy when the files are no longer needed.

Other embodiments herein may relate to validating activity information associated with healthcare related information. As described above, activity information specified by a user, such as a destination location to which a file is presumed to be checked out or copied, may differ from an actual destination location to which the file is copied. The data management system 110 may implement a comparison of the presumed destination location and the actual destination location to determine any inconsistencies. Any such inconsistencies may be reported to one or more users, in certain embodiments herein. In certain example embodiments, it may be assumed that the location to which a file is presumed to be checked out or copied may be considered to be the actual location to which the file is checked out or copied.

In one embodiment, a file requested by the user device 150 may be provided to the user device 150. Providing the file may include providing the file from a destination location (e.g., a file system directory, database, etc.) where it may be accessed by the user device 150. In one example, a requested file may be copied to a particular directory where it may be accessed by the user device 150. In this example, the file may be provided to the user device 150 from the directory to which it was copied. For example, when a user requests to check out “FileA,” the user may cause “File A” to be copied to directory “c:\userdata\CustomerA.” FileA may therefore be accessed from “c:\userdata\CustomerA.”

The above descriptions in FIG. 1 are for purposes of illustration and are not meant to be limiting. Other configurations, techniques, examples, etc., for securing healthcare related information may also exist. For example, while tracking and management of healthcare related information may occur on a secured network (e.g., within the region 102), other configurations may not include such a secured area. The techniques described herein may therefore be implemented within or outside of the region 102, or a similarly secured network.

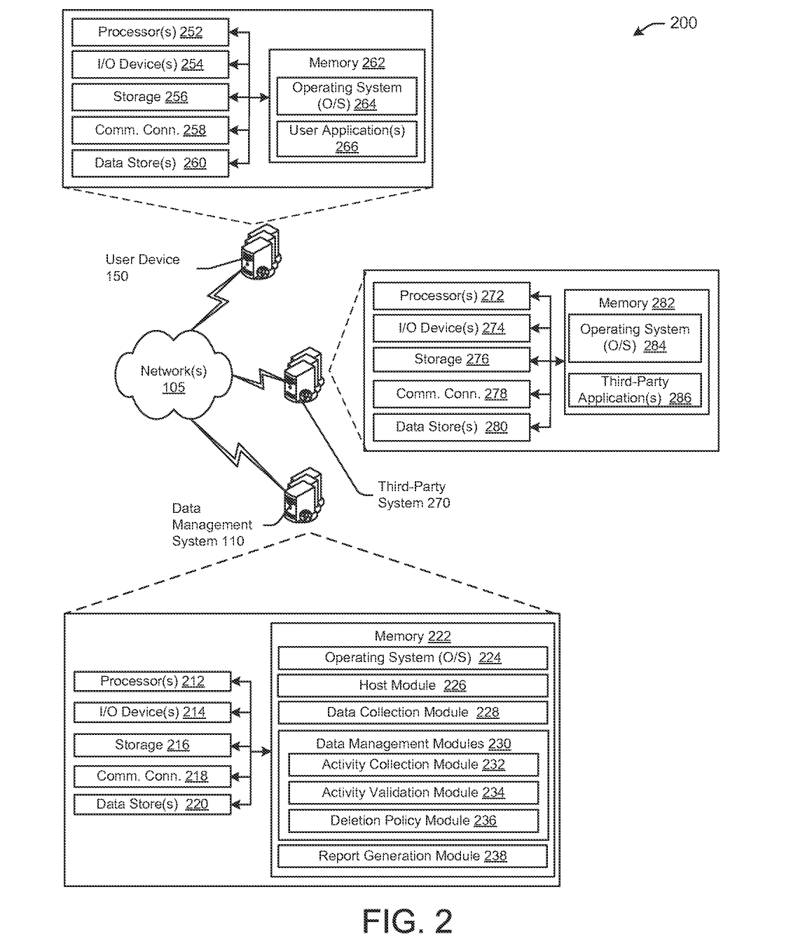

FIG. 2 depicts a block diagram of an example computing environment 200 for implementing secure life cycle tracking and management of healthcare related information, according to an embodiment of the disclosure. The example computing environment 200 may include, but is not limited to, a data management system 110, a user device 150, and a third-party device 270. Although only one of each device is shown, more may exist in other embodiments. Each of these devices may communicate with one another over the network 205. For example, the data management system 110 may receive healthcare related information from one or more third-party devices 270 and store the healthcare related information such that it may be accessed (e.g., viewed, modified, deleted, etc.) by the one or more user devices 150 over the network 205.

As used herein, the term “device” may refer to any computing component that includes one or more processors that can be configured to execute computer-readable, computer-implemented, or computer-executable instructions. Example devices can include client-type devices, output-type devices, wearable devices, personal computers, server computers, server farms, digital assistants, smart phones, personal digital assistants, digital tablets, smart cards, Internet appliances, application-specific circuits, microcontrollers, minicomputers, transceivers, kiosks, or other processor-based devices. The execution of suitable computer-implemented instructions by one or more processors associated with various devices may form special purpose computers or other particular machines that may implement or facilitate secure life cycle tracking and management of healthcare related information.

Various types of networks 205 may enable communication between the computing devices shown in FIG. 2. Such networks may include any number of wired or wireless networks. In some embodiments, other networks, intranets, or combinations of different types of networks may be used including, but not limited to, WiFi networks, WiFi Direct networks, NFC networks, Bluetooth® networks, the Internet, intranets, cable networks, cellular networks, landline-based networks, radio networks, satellite networks, other short-range, mid-range, or long-range wireless networks, or other communication mediums connecting multiple computing devices to one another.

As used herein, “healthcare related information” may refer to any information associated with providing healthcare products or services, and may include patient information, protected health information (PHI), physician or prescriber information, pharmacy information, prescription information, insurance information, other information associated with a third-party entity as described herein, etc. While certain embodiments herein refer to healthcare related information, embodiments herein are not meant to be limited to healthcare related information. Any type of information, whether sensitive information or not, may be suitable information for the processes described herein.

As used herein, the term “text file” may refer to a type of computer file that may be structures as a sequence of lines of electronic text. A text file as used herein may not include metadata or any inherent tracking features or mechanisms. Embodiments herein are not meant to be limited to text files only but may also include other types of files that have the same or at least similar features of a text file.

The data management system 110, the user device 150, and the third-party device 270 may include one or more processors configured to communicate with one or more memory devices and various other components or devices. For example, the data management system 110 may include one or more processors 212, one or more input/output (I/O) devices 214, storage 216, one or more communication connections 218, and one or more data stores 220. The one or more processors 212 may be implemented as appropriate in hardware, software, firmware, or a combination thereof. With respect to the user device 150 and the third-party device 270, the one or more processors 252 and 272, respectively, may be the same or at least similar to the processor 212 associated with the data management system 110.

The memory 222 associated with the data management system 110 may store program instructions that may be loadable and executable on the associated processor 212, as well as data generated during the execution of these programs. Depending on the configuration and type of data management system 110, the memory 222 may be volatile, such as random access memory (RAM), static random access memory (SRAM), dynamic random access memory (DRAM); or non-volatile, such as read-only memory (ROM), Electrically Erasable Programmable Read-Only Memory (EEPROM), flash memory, etc. With respect to the user device 150 and the third-party device 270, the memory 262 and 282 may be the same or at least similar to the memory 222 associated with the data management system 110.

The storage 216 associated with the data management system 110 may include removable and/or non-removable storage including, but not limited to, magnetic storage, optical disks, and/or tape storage. The disk drives and their associated computer-readable media may provide non-volatile storage of computer-readable instructions, data structures, program modules, and other data for the data management system 110. With respect to the user device 150 and the third-party device 270, the storage 256 and 276, respectively, may be the same or at least similar to the storage 216 associated with the data management system 110.

In any instance, the memory 222, 262, and 282, and the storage 216, 256, and 276, both removable and non-removable, are all examples of computer-readable storage media. For example, computer-readable storage media may include volatile and non-volatile, removable and non-removable media implemented in any method or technology for storing information such as computer-readable instructions, data structures, program modules, or other data.

The I/O devices 214 associated with the data management system 110 may enable a user to interact with the data management system 110 to, among other things, install software and/or program modules that, when executed, configure the data management system 110 to implement or facilitate the functions described herein, among other functions. The I/O devices 214 may include, but are not limited to, a keyboard, a mouse, a pen, a voice input device, a touch input device, a gesture detection or capture device, a display, a camera or an imaging device, speakers, and/or a printer. With respect to the user device 150 and the third-party device 270, the I/O devices 254 and 274, respectively, may be the same or at least similar to the I/O devices 214 associated with the data management system 110.

The one or more communication connections 218 associated with the data management system 110 may allow the data management system 110 to communicate with other devices, such as the user device 150 and the third-party device 270, via the one or more wireless and/or wired networks 205. With respect to the user device 150 and the third-party device 270, the communication connections 258 and 278, respectively, may be the same or at least similar to the communication connections 218 associated with the data management system 110.

The one or more data stores 220 may store lists, arrays, databases, flat files, etc. In some implementations, the data stores 220 may be stored in a memory external to the data management system 110 but may be accessible via one or more networks, such as with a cloud storage service. The data stores 220 may store information that may facilitate secure life cycle tracking and management of healthcare related information. Such information may include, but is not limited to, a mapping of file system directories to third-party entities such that healthcare related information from a particular third-party entity may be stored in a corresponding directory, one or more policies that indicate processes required to remove a text file including healthcare related information, access control lists that may control a user's access to third-party entities and/or files associated with the third-party entities, etc., dates or timestamp information associated with when a user performed an activity associated with healthcare related information, various information that may be used to generate a report associated with user activity associated with healthcare related information, etc.

Turning to the contents of the memory 222, the memory 222 may include, but is not limited to, an operating system (O/S) 224 and various program modules to implement or facilitate the processes described herein. Such program modules may include a host module 226, an information collection module 228, and a data information management module 230. Each of these modules may be implemented as individual modules that provide specific functionality associated with secure life cycle tracking and management of healthcare related information, as described herein. Alternatively, one or more of the modules may perform all or at least some of the functionality associated with the other modules.

The operating system 224 may refer to a collection of software that manages computer hardware resources and provides common services for computer programs to enable and facilitate operation of such programs. An example of such common services may include copying a file from a source directory to a destination directory, storing information in a database, etc. Example operating systems may include UNIX, Microsoft Windows, Apple OS X, iOS, Android, Chrome OS, etc.

The host module 226 may initiate, receive, process, and/or respond to requests from various computing devices, such as the user device 150 and the third-party device 270. For example, the host module 226 may provide web portal functionality accessible by the user device 150, including web-based information using Hypertext Markup Language (HTML), extensible Markup Language (XML), or other suitable languages or program code. In this way, the host module 226 may serve as a web server of healthcare related information, and other information, to the user device 150 and the third-party device 270.

The host module 226 may also authenticate a user's access to healthcare related information. In so doing, the host module 226 may determine to which healthcare related information the user has access. In one embodiment, the host module 226 may access an access control list, or similar mechanism, to determine a user's access rights or permissions to various third-party entities, types of information, etc. Upon determining a user's access rights, the host module 226 may display healthcare related information only associated with third-party entities to which the user has access permissions. For example, a directory identifier corresponding to a third-party entity and files associated with the third-party entity may be displayed. In one embodiment, the host module 226 may display only one third-party entity directory and files associated with the directory at a time, notwithstanding a user having been granted access to multiple third-party entity directories.

The host module 226 may also include program instructions for enabling access to databases, or other storage, where healthcare related information may be stored, and subsequent retrieval of the healthcare related information from such sources. Example program instructions may be associated with Structured Query Language (SQL) commands, Oracle, Sybase, DB2, or other database management tools.

The data collection module 228 may receive healthcare related information, and/or other information, from one or more third-party devices 270, in one example. In one configuration, the data collection module 228 may include or work in conjunction with a program module or application to facilitate secure transfer of the healthcare related information. In one embodiment, Slingshot Software may facilitate the secure transfer. Various other software, program modules, encryption techniques, etc., may also be used to enable secure file transfer in other embodiments.

The data collection module 228 may also store the received healthcare related information. Such information may be stored in the data store 220 or other storage. In one embodiment, the healthcare related information may be stored in association with the third-party from which it was received. In so doing, the data collection module 228 may parse at least a portion of the healthcare related information to identify a third-party associated with the information, and may also identify a directory in the data store 220, a table in a database, or other location in which to store the healthcare related information.

The data management module 230 may manage a user's access to healthcare related information, which may be stored in a file (e.g., a text file). Such access may include viewing a file, editing or modifying a file, adding a file, or deleting a file associated with healthcare related information. The data management module 230 may include various program modules to implement or facilitate such functionality, such as but not limited to, an activity collection module 232, an activity validation module 234, and a deletion policy module 236.

The activity collection module 232 may receive information associated with a user's access to healthcare related information. Such information may include, but is not limited to, an identification of a file associated with the healthcare related information, an identification of a user who accessed the file, dates and times at which the file was accessed, a source directory or location in which the file was accessed, a destination directory or location to which the file is checked out or stored for access by the user, etc. The activity collection module 232 may determine such information from a web page or other information resource in which a user may specify the information in association with accessing a file, in one embodiment. Examples of the functionality provided by the activity collection module 232 are described in greater detail below.

The activity collection module 232 may also store the activity information. The activity information may be stored in the data store 220 or other storage, where it may be accessed by the report generation module 238 to generate one or more reports based on the activity information, as will be described in greater detail below.

The activity validation module 234 may validate the user activity information. In so doing, the activity validation module 234 may determine whether the information specified by the user in association with accessing healthcare related information is valid information. In one example, the activity validation module 234 may generate a list of files existing in one or more directories or storage locations associated with a third-party entity, and may compare the list of files to a file checked out by a user to determine whether the destination indicated by a user who requested access to the file (e.g., the presumed location of the file) is actually the location to which the user checked out the file. If a match exists, then the activity information indicated by the user (e.g., the destination to which the file was checked out) may be successfully validated. If a match does not exist, then the activity validation module 234 may determine that a discrepancy exists and may provide information associated with the discrepancy (e.g., user specified location of the file, actual location of the file, etc.) to the report generation module 238 for generating a report to various users, as will be described in greater detail below.

A similar comparison may be performed between information actually stored in a database and information indicated by a user. For example, database names and tables may be queried (e.g., via SQL) to determine a listing of healthcare related information, and a comparison may be performed between the determined listing and the presumed destination location of the healthcare related information specified by the user. Numerous other examples may exist.

The activity validation module 234 may be initiated periodically, at a scheduled time, upon receiving a validation request (e.g., from a user or the report generation module 238), or based on the occurrence of various events, such as receiving an indication (e.g., from the activity collection module 232) that a user has requested access to healthcare related information, receiving an indication that activity information associated with a user's request to access healthcare related information has been stored, or upon the occurrence of other events. In one example, a user's request to access information may trigger generation of a report if it is determined that a user and/or a user device has previously requested information that has not yet been deleted. Such a determination may be made by analyzing stored activity information associated with the user, as well as a status associated with whether files indicated in the stored activity information have been deleted or indicated as deleted, in one embodiment.

The deletion policy module 236 may facilitate removal of healthcare related information. For example, the deletion policy module 236 may receive an indication that a file has been requested to be deleted. In one embodiment, the indication may be received from the activity collection module 232. The deletion policy module 236 may also determine a policy associated with deleting the file. Such a policy may indicate one or more processes that may be required to delete a file in compliance with the policy. For example, a user may be required to initiate a file removal software application or program (e.g., Eraser) that removes the entire contents of the file. As another example, the user may be required to initiate an additional program or utility to verify that the file was successfully deleted, initiate a program to notify certain users that the file was removed, etc.

Such processes may be presented as a checklist of processes required for completion in association with deleting a file, in one embodiment. A user's selection of processes in the checklist may be stored in the data store 220, or other storage, where it may be accessed by the report generation module 238 for use in generating a report.

In certain embodiments herein, the deletion policy module 236 may determine a policy associated with deleting a file based at least in part on a location or a type of storage of the file requested for deletion. For example, a first policy may be used to delete a file that is located in a type of storage that is a database, while a second policy may be used to delete a file that is located in a type of storage that is a file system directory, and so forth.

The report generation module 238 may generate one or more reports associated with the processes described herein. One such report may be based on activity information associated with healthcare related information. For example, the report generation module 238 may generate a notification to a user who accessed (e.g., checked out) a file that includes the healthcare related information. The notification may include, but is not limited to, an identification of one or more users, such as the user who accessed the file, the user's supervisor or other individuals in an organization to which the user may belong (which may be determined by the report generation module 238 based on analysis of an organizational chart or similar information), a data steward or person responsible for the healthcare related information in the file, etc.; a destination location to which an accessed file may be stored, as may be indicated by the user; a purpose for which the file was accessed, as may be indicated by the user; a third-party entity associated with the healthcare information in the file; a date and time at which the file was accessed; and an amount of time that has elapsed since the file was last accessed.

Another example report generated by the report generation module 238 may include information associated with a discrepancy between activity information that is presumed to be accurate, such as the destination location of a checked out file specified by a user when prompted, and the actual destination location of the checked out file, which may vary in some embodiments. When a difference exists between such information, a discrepancy report may be generated. The discrepancy report may include an identification of the presumed destination location and the actual destination location, an identification of a user who provided the activity information, an identification of a program or utility that was executed to determine the actual location of the checked out file (e.g., the activity validation module 234), etc.

A report generated by the report generation module 238 may be sent to user devices 150 associated with various users, such as a user who accessed the file, an owner or person responsible for the healthcare related information in the accessed file, etc. The report generation module 238 may be initiated periodically, at a scheduled time, upon the occurrence of certain events, etc., as described above.

The user device 150 may be configured to facilitate the processes described herein. For example, the memory of the user device 150 may include an operating system (O/S) 264, which may be the same or at least similar to the operating system 224 associated with the data management system 110. The user device 150 may also include one or more user applications 266 that may configure the user device 150 to perform various functions, such as displaying content (e.g., via a web browser). Such content may include healthcare related information and web page content that may, for example, receive user input (e.g., activity information associated with the healthcare related information), among other content. The one or more user applications 266 may also include any number of software applications or program modules that may enable a user of the user device 150 to perform various computing functions.

The third-party device 270 may also be configured to facilitate the processes described herein. For example, the memory 282 of the third-party device 270 may include an operating system (O/S) 284, which may be the same or at least similar to the operating system 224 associated with the data management system 110. The third-party device 270 may also include one or more third-party applications 286 that may configure the third-party device 270 to perform various functions, such as sending healthcare related information to the data management system 110. Various program modules may enable a user to display and select healthcare related information for sending, as well as perform any number of other computing functions.

The above descriptions in FIG. 2 are for purposes of illustration and are not meant to be limiting. Various other examples, configurations, etc., may also exist. For example, the communication described between the devices in FIG. 2 may involve different numbers and types of devices, types of information, etc.

FIG. 3 depicts an example data flow diagram 300 for exchanging information to facilitate secure life cycle tracking and management of healthcare related information, according to an embodiment of the disclosure. In the non-limiting example shown, healthcare related information may be exchanged between the data management system 110, the user device 150, and the database 370. For example, the data management system 110 may send, to the user device 150 for display on the web page 312, information to facilitate secure life cycle tracking and management of healthcare related information, as shown by communication 301. Such information may include, but is not limited to, a listing of files to which a user of the user device 150 has access, a check box selection indicator associated with each file, one or more destination locations for checking out a file, and a text box for inputting comments associated with a purpose for checking out the file, among other content. Responses to requests for such information may be tracked and monitored, as described further below.

As shown by communication 303, responses to the information on the web page 312 (or activity information as referred to herein) may be received by the data management system 110. For example, a user desiring to check out HCInfo.txt (a text file) may indicate that the file is being checked out to both a location in Database A and File System Directory B. As shown by the communication 305, the data management system 110 may store the activity information in the database 370 (or other storage) for subsequent access and retrieval for reminding or notifying the user about the checked out file. In this way, healthcare related information may be tracked to the file level. For example, the user who accessed (e.g., checked out) the file, the locations at which the file was replicated, the time at which the checked out file was replicated, etc., may be known each time the file is accessed or checked out such that the file may be tracked throughout its entire life cycle, or until it is deleted according to a policy as described herein. A requested file (or portion of healthcare related information) may be provided to the user device 150 by the data management system 110.

In certain embodiments herein, text files may be tracked to the file level in such a manner. Although certain embodiments relate to tracking text files to the file level, other types of files, such as HTML, XML, Word Document, Excel, etc., may also be tracked.

As described above, a notification or report may be generated and sent to various users. To facilitate such generation, the stored activity information may be accessed from the database 370, as shown by communication 307. All or at least a portion of the activity information may be sent to the user device 150 as a report, as shown by communication 304. An example report is illustrated on the web page 314. As shown, the generated report may include a file name of checked out files that remain active (e.g., the HCInfo.txt file checked out by the user on the web page 312, and the Summary.txt file); an identification of the user who checked out the files (e.g., User A); a date the file was checked out (e.g., Jan. 1, 2014 at 3:15 PM); a destination location of the checked out file (e.g., Database A for HCInfo.txt, as indicated by the user on the web page 312); and a duration that the files have been checked out (e.g., 46 days, 19 hours).

The generated report may remind the user that the checked out files illustrated on the web page 314 remain active, which may trigger the user to delete the active files, in one embodiment. To facilitate deleting the active files, the data management system 110 may receive a selection of a file to be deleted (e.g., HCInfo.txt), as shown by communication 311. The data management system 110 may determine one or more locations of the file requested for deletion (e.g., Database A and File System Directory B as shown on web page 312), and may further determine a policy associated with each location. A different policy may exist based on a location of a file requested for deletion. For example, one policy may be used to delete a file from Database A, while a different policy may be used to delete a file from the File System Directory B.

In the present example, a policy associated with deleting the HCInfo.txt file from the File System Directory B may be as shown on the web page 316. The policy may be communicated from the data management system 110 to the user device 150, as shown by communication 313. The policy may require acknowledgement of execution of a file deletion program to completely remove the content of the HCInfo.txt file from a hard disk or other storage that stores the HCInfo.txt file, acknowledgement that a separate utility to verify the deletion of the HCInfo.txt file was executed, and an acknowledgement that a notification of the deletion was sent to certain users, such as the owner or person responsible for the HCInfo.txt file, among other acknowledgements.

In some embodiments, the policy may be sent to the user via the communication 304. According to these embodiments, the data management system 110 may determine, for each file in the report, a policy to be used when deleting each file indicated in the report. In one example, a user of the user device 150 may be displayed a policy that corresponds to a file selected by the user for deletion. In this way, the user may follow a particular policy for deleting a file.

A user may acknowledge the policy requirements by selecting a corresponding check box as shown, and information associated with the selections may be sent from the user device 150 to the data management system 110, which may store the information in the database 370, in one embodiment.

The above descriptions associated with FIG. 3 are for purposes of illustration and are not meant to be limiting. Different numbers and types of files, storage mechanisms, policy information, number and types of computing devices, etc., may exist in other embodiments.

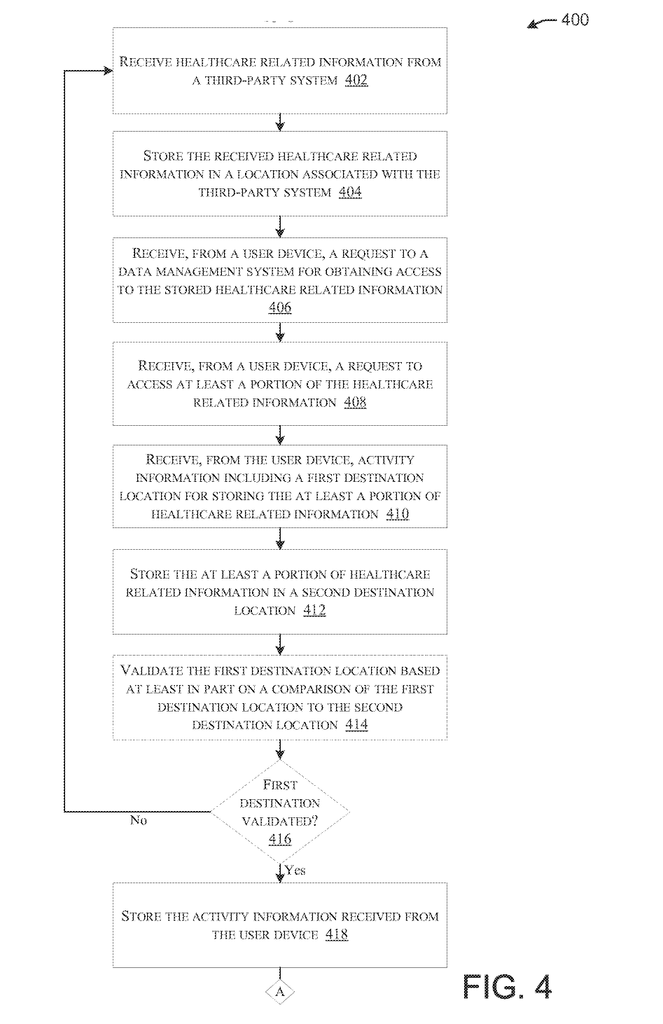

FIG. 4 depicts a flow diagram of an example process 400 for implementing secure life cycle tracking and management of healthcare related information, according to an embodiment of the disclosure. In one example embodiment, the example process 400 may be implemented by the data management system 110 in FIG. 2. Referring now to FIGS. 1, 2, and 4, the example process 400 may begin at block 402, where healthcare related information may be received from a third-party system (e.g., via the data collection module 228), such as health plan administrators, drug manufacturers, disease management entities, pharmacy point of service devices, labs, other healthcare provider systems (such as those described above), via, for example, the network 105, etc. Example information that may be received includes, but is not limited to, patient information, protected health information (PHI), physician or prescriber information, pharmacy information, prescription information, insurance information, or generally may include any information associated with providing healthcare products or services.

The healthcare related information received from the third-party device 160a may be stored in various locations, such as the database 140 in FIG. 1, the one or more data stores 220 in FIG. 2, or other storage. In one embodiment, the received healthcare related information may be stored in a logical location, such as a file system directory, a database table, etc., that corresponds to the third-party system, at block 404. According to one example, the received healthcare related information may be parsed (e.g., by the data collection module 228) to determine an identification of the third-party entity and a type of information included in a message from the third-party entity. In one configuration, each message may include one or more delimiters, such as a colon, semi-colon, or other character that may be used consistently throughout a message to indicate a separation between different fields of information. For example, a message may include “Insurance Provider A: healthcare related information: Patient Name: Patient Address: Prescriber Name: Prescribed Drug, Adjudication Message,” where “Insurance Provider A” is the name of the third-party entity and the healthcare related information indicates that the type of information in the message is healthcare related. A colon, as shown, may separate such information such that the data collection module 228 may identify each field (e.g., each portion separated by a colon) in the message. Other techniques for identifying the third-party entity, type of information, etc., may exist in other examples. Continuing the present example, the data collection module 228 may store the healthcare related information in a directory named “Insurance Provider A” to correspond to the third-party entity from which the information was received. Healthcare related information may be further stored in a separate subdirectory that may be unrelated to other types of information (e.g., non-healthcare related information) that may be provided by third-party entities. In further embodiments, the type of healthcare related information, such as patient data, physician data, etc., may also be specified in the message, followed by the actual data or information.

At block 406, a request to access a data management system (e.g., the data management system 110 in FIG. 2) to gain access to healthcare related information may be received (e.g., by the host module 226) from a user device utilized by a user. The user and/or the user device may be authenticated prior to granting access to healthcare related information. In one embodiment, a unique identifier associated with the user (e.g., a login name and/or password) and/or a unique identifier associated with the user device (e.g., a Media Access Control (MAC) address or other unique identifier) may be validated to identify the user and/or the user device and access permissions for one or both of the user or the user device. In one embodiment, the host module 226 may receive an identifier of a user at a login prompt and may receive a unique identifier of a user device via a cookie, for example, which may be received by the data management system 110 at the time of login, as a non-limiting example.

In one embodiment, a determination may be made (e.g., by the host module 226) as to which healthcare related information the user and/or user device has access. In one embodiment, the host module 226 may access an access control list, or similar mechanism, to determine a user's access rights or permissions to various third-party entities, types of information, etc., by comparing unique identifiers in the access control list to the unique identifiers for the user and/or the user device received during the authentication process. As an example, a user may have access to Insurance Provider A's healthcare related information, as well as Insurance B and Insurance C's healthcare related information, but may not be able to see any information associated with Insurance Provider D, and may only be able to access information other than healthcare related information for Insurance Provider E.

Upon determining the access rights for a user and/or a user device, the host module 226 may display healthcare related information only associated with third-party entities to which the user and/or user device has access permissions. For example, a directory identifier corresponding to a third-party entity and files associated with the third-party entity may be displayed. In one embodiment, the host module 226 may display only one third-party entity directory and files associated with the directory at a time, notwithstanding a user having been granted access to multiple third-party entity directories. To access files associated with a third-party entity that are not presently shown, the user may be required to log out of the current file system and choose an option (e.g., via the host module 226) to “next third-party entity,” or a similar trigger that may cause the data management system 110 to display files associated with the next third-party entity, if one exists, without displaying any of the other third-party entities to which the user may have access.

At block 408, a request to receive access to at least a portion of the healthcare related information may be received (e.g., by the host module 226) from a user device (e.g., the user device 150), via for example, the network 105 at block 406. In one example embodiment, an indication of a file name may be received from the user device upon a user of the user device specifying a file for access (e.g., to check out, edit, modify, delete, view, etc.). Such a file may include the portion of healthcare related information to which access is requested.

Activity information may be received from the user device (e.g., by the activity collection module 232 of the data management system 110) via, for example, the network 105 at block 410. Example activity information may include, but is not limited to, an identification of a file accessed (e.g., checked out) by a user device, an identification of the user device and/or the user who accessed the file, a destination location to which the accessed file may be stored, etc.

In certain example embodiments, the activity information received from the user device may be presumed to be valid. For example, a destination location specified by the user may be presumed to be the actual location to which the accessed file is stored. In one example embodiment, the destination location specified by the user may be optionally validated (e.g., by the activity validation module 234). At block 414, such validation may include comparing the destination location specified by the user to an actual location to which the portion of healthcare related information requested for access is stored (e.g., by a copy utility or similar tool to replicate or move files in a file system) (as performed in block 412). Put another way, the activity validation module 234 may validate the user activity information to determine whether the information specified by the user in association with accessing healthcare related information is valid information.

In one example, the activity validation module 234 may generate a list of files existing in one or more directories or storage locations associated with a third-party entity, and may compare the list of files to a file checked out by a user to determine whether the destination indicated by a user who requested access to the file (e.g., the presumed location of the file) is actually the location to which the user checked out the file, at block 416. If a match exists, then the activity information indicated by the user (e.g., the destination to which the file was checked out) may be successfully validated, and the activity information received from the user device may be stored at block 418. If a match does not exist, then the activity validation module 234 may determine that a discrepancy exists and may provide information associated with the discrepancy (e.g., user specified location of the file, actual location of the file, etc.) to the report generation module 238 for generating a report to various users, as will be described in greater detail below. A similar comparison may be performed between information actually stored in a database and information indicated by a user. For example, database names and tables may be queried (e.g., via SQL) to determine a listing of healthcare related information, and a comparison may be performed between the determined listing and the presumed destination location of the healthcare related information specified by the user. Numerous other examples may exist. In certain example embodiments herein, the validation described at blocks 414 and 416 may not be performed.

One or more reports may be generated (e.g., by the report generation module 238) based at least in part on the stored activity information at block 420. As described above, the generated reports may include the file name, an indication that the named file has been accessed (e.g., checked out), a date and time of the access, a location of the file on the data management system (e.g., a file system directory, database, database table, etc.) or at a location accessible by the data management system.

A generated report may also include a policy that may be used to delete a file that includes healthcare related information that is associated with the stored activity information. Such a policy may be determined (e.g., by the deletion policy module 236) at block 422. In one embodiment, the policy may be determined based on a location of the file that is requested to be deleted (e.g., Database A and Directory B as shown on web page 312). A different policy may exist based on a location of a file requested for deletion. For example, one policy may be used to delete a file from the Database A, while a different policy may be used to delete a file from the Directory B. Such policies may ensure that the entire contents of sensitive healthcare related information are deleted in their entirety, among other things. For example, deleting healthcare related information from a database may require different processes than deleting healthcare related information from a hard disk that stores a file system directory. The policies described herein may display such requirements to a user, who may read the requirements, follow the requirements, check the requirements by selecting an indicator corresponding to the requirements when the requirements have been performed, and send a notification when one or all of the requirements have been performed.

A generated report may be sent (e.g., by the report generation module 238) to one or more user devices utilized by various users, users associated with the stored activity information, such as a user who requested access to the file, an owner or person responsible for healthcare related information in the file, etc., at block 424.

In one embodiment, the generated report may be sent to the user over the network 205 using an electronic mail address of a user utilizing the user device. In one embodiment, the report generation module 238 may determine an electronic mail address of a user for whom access was authenticated (e.g., at block 406). The electronic mail address associated with the user may be identified in a cookie received from a user device utilized by the user upon receiving a request to access the data management system at block 406. The electronic mail address may also be obtained by accessing user account information associated with the user, for example, based on a previous registration by the user to access the data management system. After obtaining the electronic mail address, the generated report may be sent to the electronic mail address that corresponds to a user account for the user.

In another embodiment, the generated report may be sent to the user device using the MAC address, Internet Protocol (IP) address of the user device, or other unique identifications for the user device. The generated report may be sent as an HTML message, XML message, Simple Mail Transfer Protocol (SMTP) message, or via other communication protocols.

Upon the user device receiving the generated report, the user device may present the report to a user utilizing the user device (e.g., via a user application 266). The user may select a link associated with the report, for example, and may be directed to the data management system (e.g., after authenticating the user and/or the user device), where the report may be accessed.

As described above, the information in the report may include, but is not limited to, an identification of one or more users, such as the user who accessed the file, the user's supervisor or other individuals in an organization to which the user may belong (which may be determined by the report generation module 238 based on analysis of an organizational chart or similar information), a data steward or person responsible for the healthcare related information in the file, etc.; a destination location to which an accessed file may be stored, as may be indicated by the user; a purpose for which the file was accessed, as may be indicated by the user; a third-party entity associated with the healthcare information in the file; a date and time at which the file was accessed; an amount of time that has elapsed since the file was accessed; and a policy associated with each file indicated in the report.

As mentioned above, the report sent to the user device may include a policy that may have one or more requirements for a user to complete when deleting files that include healthcare related information or other sensitive information. According to this embodiment, a policy for use in deleting a file, for example, each file indicated in a report, may be determined. In one example, a user of the user device may be displayed a policy that corresponds to a file selected by the user for deletion. The user may read the policy and check a checkbox or indicator next to each policy requirement after it has been completed. After all or at least a portion of the policy requirements are completed, an indication of such completion may be sent to the data management system, where an indication may be set that a particular file was successfully removed.

The policy may be a portion of HTML, XML, or another language or program code, as shown on the web page 316 in FIG. 3. In one embodiment, the policy may be a link or reference on a web page that, when clicked, directs the user device to a server (e.g., the data management system 110) to obtain the policy information.

In one embodiment, the data management system (e.g., via the host module 226) may receive information associated with deletion of a file at a user device in response to sending the one or more reports to the user device. The user device and the data management system may communicate with each other regarding the file deletion. In one example, the data management system (e.g., the host module 226) may receive an indication that a policy requirement has been performed at the user device. For example, the user device may execute a file removal application that may remove the entire contents of a file from a hard disk, execute a utility program to ensure that the file was completely removed, and send one or more messages to various computing devices regarding performance of the policy requirement.

In one embodiment, the indication of performance of a policy requirement may be sent after a user selects a check box associated with the policy requirement. An identification of the policy requirement, among other information, may be sent to the data management system. The data management system (e.g., via the deletion policy module 236) may compare the received indication with a stored status of each requirement associated with the policy to determine whether all policy requirements have been completed. If all requirements for the policy have not been performed at block 428, then the user device may continue to send additional indications that a respective policy requirement has been performed. If all policy requirements have been met, then processing may return to block 402, where healthcare related information may be received.

In one embodiment, a user device (e.g., via the user application 266) may delay sending an indication that any policy requirement has been met until all policy requirements have been met. The user device may determine whether a checkbox, or similar component, associated with each policy requirement has been selected. If so, the user device may then send a message to the data management system that the policy requirements required for deletion have been met, in one embodiment. The message may include an identification of the policy requirement, as well as identifications for each of the policy requirements that were performed, among other information. The data management system (e.g., via the deletion policy module 236) may compare the received information with corresponding stored information (e.g., comparing each requirement indicated as completed by the user device to each stored requirement associated with the relevant policy) to determine whether the deletion of a file was performed according to the proper policy.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks.

As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A computer-implemented method comprising:
receiving, by a data management system from a user device, a request to access a file comprising at least a portion of the healthcare information, wherein the request comprises an identification of the file, an identification of at least one first destination location associated with access to the file, and an identification of a user of the user device;
storing, by the data management system, the request;
providing, by the data management system to the user device, the requested file via at least one second destination location from which the file is accessible;
generating, by the data management system, a report comprising at least a portion of information in the request;
transmitting, by the data management system, the generated report to the user device; and
in response to the transmission of the generated report to the user device, receiving, by the data management system, information associated with a request to delete the file.

2. The computer-implemented method of claim 1, wherein the file comprises a text file.

3. The computer-implemented method of claim 1, wherein providing the requested file comprises checking out the text file to the at least one second destination location, wherein the at least one second destination location matches the at least one first destination location.

4. The computer-implemented method of claim 1, wherein the user device comprises a first user device and the user comprises a first user, and wherein the method further comprises:
receiving, by the data management system from a second user device associated with a second user, a request to check out the file, the file requested to be checked out from the at least one first destination location to at least one third destination location; and
sending, by the data management system, the generated report to an adjudicator of healthcare claims, wherein the report comprises a respective identification of the first user, the at least one first destination location from which the first user accessed the file, the second user, and the at least one third destination location from which the second user accessed the file.

5. The computer-implemented method of claim 1, further comprising:
determining, by the data management system, that the at least one first destination location does not match the at least one second destination location, wherein the determination comprises:
determining one or more first files associated with the at least one second destination location;
comparing the one or more first files to the requested file; and
determining that the one or more first files do not match the requested file.

6. The computer-implemented method of claim 1, further comprising:
determining, by the data management system, a policy for deleting the file, wherein the policy comprises one or more requirements for deleting the file;
wherein the report sent from the data management system to the user device comprises the policy; and
wherein the information in the request to delete comprises an indication that at least one requirement of the one or more requirements was performed.

7. The computer-implemented method of claim 6, wherein the policy is determined based at least in part on a type of storage of the file, the type of storage comprising a file system directory or a database.

8. The computer-implemented method of claim 1, wherein the information in the request to delete the file comprises an indication that all requirements of the policy have been performed.

9. The computer-implemented method of claim 1, further comprising:
in response to receiving the request to access the file from the user device, determining, by the data management system, that the user device previously accessed a different file;
wherein the report is generated in response to the determination that the user device previously accessed the different file.

10. The computer-implemented method of claim 1, wherein the generated report further comprises an elapsed time since the file was last accessed.

11. A system comprising:
at least one memory that stores computer-executable instructions; and
at least one processor configured to access the at least one memory, wherein the at least one processor is configured to execute the computer-executable instructions to:
receive, from a user device, a request to access a file comprising at least a portion of the healthcare information, wherein the request comprises an identification of the file, an identification of at least one first destination location associated with access to the file, and an identification of a user of the user device;
store the request;
provide, to the user device, the requested file via at least one second destination location from which the file is accessible;
generate a report comprising at least a portion of information in the request;
transmit the generated report to the user device; and
in response to the transmission of the generated report to the user device, receive information associated with a request to delete the file.

12. The system of claim 11, wherein the file comprises a text file.

13. The system of claim 11, wherein providing the requested file comprises checking out the text file to the at least one second destination location, wherein the at least one second destination location matches the at least one first destination location.

14. The system of claim 11, wherein the user device comprises a first user device and the user comprises a first user, and wherein the at least one processor is further configured to execute the computer-executable instructions to:
receive, from a second user device associated with a second user, a request to check out the file, the file requested to be checked out from the at least one first destination location to at least one third destination location; and
send the generated report to an adjudicator of healthcare claims, wherein the report comprises a respective identification of the first user, the at least one first destination location from which the first user accessed the file, the second user, and the at least one third destination location from which the second user accessed the file.

15. The system of claim 11, wherein the at least one processor is further configured to execute the computer-executable instructions to:
determine that the at least one first destination location does not match the at least one second destination location, wherein the computer-executable instructions for the determining further comprises computer-executable instructions to:
determine one or more first files associated with the at least one second destination location;
compare the one or more first files to the requested file; and
determine that the one or more first files do not match the requested file.

16. The system of claim 11, wherein the at least one processor is further configured to execute the computer-executable instructions to:
determine a policy for deleting the file, wherein the policy comprises one or more requirements for deleting the file;
wherein the report sent from the data management system to the user device comprises the policy; and
wherein the information in the request to delete comprises an indication that at least one requirement of the one or more requirements was performed.

17. The system of claim 16, wherein the policy is determined based at least in part on a type of storage of the file, the type of storage comprising a file system directory or a database.

18. The system of claim 11, wherein the information in the request to delete the file comprises an indication that all requirements of the policy have been performed.

19. The system of claim 11, wherein the at least one processor is further configured to execute the computer-executable instructions to:
in response to receiving the request to access the file from the user device, determine that the user device previously accessed a different file;
wherein the report is generated in response to the determination that the user device previously accessed the different file.

20. The system of claim 11, wherein the generated report further comprises an elapsed time since the file was last accessed.
